(19) United States
(12) Patent Application Publication
(10) Pub. No.: US 2025/0043058 A1
(43) Pub. Date: Feb. 6, 2025

(54) IMIDE-CONTAINING POLYOLS, METHOD FOR MAKING IMIDE-CONTAINING POLYOLS AND METHOD FOR USING THE IMIDE POLYOLS

(71) Applicant: Dow Global Technologies LLC, Midland, MI (US)

(72) Inventors: Weijun Zhou, Sugar Land, TX (US); William J. Harris, Brazoria County, TX (US)

(21) Appl. No.: 18/717,466

(22) PCT Filed: Dec. 13, 2022
(86) PCT No.: PCT/US2022/052615

§ 371 Date: Jun. 7, 2024

Related U.S. Application Data
(60) Provisional application No. 63/290,715, filed on Dec. 17, 2021.

(51) Int. Cl. C08G 18/46; C08G 18/18; C08G 18/22; C08G 18/42; C08G 18/48; C08J 9/14; C08K 5/521

(52) U.S. Cl. CPC C08G 18/4646; C08G 18/1841; C08G 18/225; C08G 18/4202; C08G 18/4808; C08J 9/141; C08K 5/521; C08G 2110/0025; C08J 2205/10; C08J 2375/06

(57) ABSTRACT

Polyol compositions that contain imide groups are prepared by producing imide compounds from trimellitic anhydride and an aromatic aminoacid or an aromatic diamine, then esterifying the imide compounds with one or more polyols that have hydroxyl equivalent weights of 30 to 500. Aromatic carboxylic acid derivatives may be present during the esterification step to produce polyol compositions that contain species that have imide groups, and other species that do not have imide groups. The polyol compositions are useful in making isocyanate-based polymers, in particular polyurethane and/or polyurethane-isocyanuranate foams. The presence of the imide groups in the isocyanate-based polymers imparts fire retardant properties.

This invention relates to imide-containing polyols and methods for making and using them.

Rigid polyurethane and polyisocyanurate foam is used as thermal insulation material in buildings, vehicles and appliances, among others. Foam of this type is made by reacting a foam formulation that includes one or more isocyanates, one or more polyols, and one or more blowing agents.

These foams are often required to be fire resistant. This is usually accomplished by adding copious amounts of various fire retardants to the foam formulation. These fire retardants then become incorporated into the foam product.

Many of the common flame retardants are halogenated materials which are coming under regulatory pressure in some jurisdictions. Thus, there is a desire to reduce or even eliminate the use of these halogenated materials while maintaining the desired fire resistance in the foam.

It has been suggested to incorporate aromatic imide structures into the foam; the imide is thought to contribute to fire resistance. CN 1046228979A, for example, describes an imide-modified polyol made by reacting trimellitic anhydride and p-aminobenzoic acid to produce an imide structure that contains carboxylic acid groups. This imide structure is further reacted with ethylene glycol or diethylene glycol to produce the imide-modified polyols. The imide-modified polyol is only used in minor quantities when producing polyurethane foam; multiple additional polyols including high viscosity sucrose-initiated polyether polyols are required in the foam formulation. Furthermore, large amounts of both phosphorus-containing- and halogenated flame retardants are needed.

US 2020/0299454, recognizing the problem of high viscosities with trimellitic anhydride-based, imide-containing polyols, attempts to resolve the problem by substituting a carboxylic anhydride that lacks an additional carboxylic acid group (such as phthalic anhydride) for trimellitic anhydride. This produces monols having terminal imide groups and/or aliphatic polyester polyols with pendant imide groups.

WO 2021/030115 also describes imide-modified polyols, both aromatic and aliphatic, and their use to make thermal insulating foam. The imide-modified polyol is made via a process that produces high product viscosities and low imide content in the aromatic imide products. Foams made using those polyols but without a halogenated flame retardant perform much more poorly than those made with the halogenated flame retardant.

The invention in one aspect is a method of making an imide-modified polyol composition, comprising the steps of
a) forming one or more imide group-containing compounds having terminal carboxylic acid groups by reacting trimellitic anhydride with an aromatic aminoacid or an aromatic diamine in the presence of 0 to 3 parts by weight of another carboxylic acid anhydride and/or a polycarboxylic acid per 100 parts by weight of the trimellitic anhydride;
b) optionally combining the one or more imide group-containing compounds having terminal carboxylic acid groups with one or more aromatic dicarboxylic acid derivatives that contain no imide groups selected from aromatic carboxylic acid anhydrides, aromatic dicarboxylic acids, aromatic dicarboxylic acid halides, and aromatic dicarboxylic acid dialkyl esters, wherein the mole ratio of the imide group-containing compounds and the aromatic dicarboxylic acid derivatives is at least 25:75;
c) then esterifying the one or more imide group-containing compounds having terminal carboxylic acid groups and the one or more aromatic carboxylic acid derivatives if present by reaction with one or more polyols having a hydroxyl equivalent weight of 30 to 500 g/equivalent to produce an imide-modified polyol composition,
wherein the imide-modified polyol composition has an acid number of no greater than 2 mg KOH/gram, has a hydroxyl number of 150 to 275 mg KOH/g and contains 0.50 to 1.75 moles of aromatic imide groups per kilogram of imide-modified polyol composition.

The invention is also an imide-modified polyol composition produced in the foregoing process.

In another aspect, the invention is a method for preparing a rigid isocyanate-based foam. The invention comprises forming a reaction mixture and reacting the reaction mixture to produce the rigid isocyanate-based foam, wherein the reaction mixture comprises
a) at least one aromatic polyisocyanate in an amount to provide an isocyanate index of 100 to 600;
b) polyols, wherein the polyols include at least 25% by weight of the imide-modified polyol composition of the invention and 0 to 75% by weight of one or more non-imide-modified polyols, and wherein the imide content of the polyols is 0.125 to 1.75 moles of imide groups per kilogram;
c) at least one blowing agent;
d) at least one halogenated and/or phosphorus-containing flame retardant;
e) at least one foam-stabilizing surfactant; and
f) at least one urethane and/or isocyanate trimerization catalyst.

The imide-modified polyol composition is made by a process that includes a step of forming an imide group-containing compound having terminal carboxylic acid groups. This is accomplised by reacting trimellitic anhydride with an aromatic aminoacid and/or an aromatic diamine.

The aromatic aminoacid is characterized in having a single primary amino group bonded directly to a carbon atom of an aromatic ring, and in also having a carboxyl group bonded to a carbon atom of the same aromatic ring, or to a carbon atom of a different aromatic ring. The aromatic aminoacid preferably has only one carboxyl group. The aromatic aminoacid also preferably lacks any groups, apart from the amino group and the carboxylic acid group(s), that are reactive with a carboxylic acid, amine or hydroxyl group under the conditions of the reaction(s) that produce the imide-modified polyol composition. A preferred aromatic aminoacid is aminobenzoic acid, especially the para-isomer.

The aromatic diamine is characterized in having two primary amino groups, each bonded directly to a carbon atom of an aromatic ring. Both primary amino groups may be bonded to carbon atoms of the same aromatic ring; alternatively they may be bonded to carbon atoms of different aromatic rings. The aromatic diamine lacks carboxylic acid groups and also preferably lacks other groups (other than the amino groups) that are reactive with a carboxylic acid, amine or hydroxyl group under the conditions of the reaction(s) that produce the imide-modified polyol composition. Examples of useful aromatic diamines include phenylene diamine (any isomer or mixture of isomers), 2,2′-, 2,4′- and/or 4,4′-methylenedianiline, toluene diamine (any isomer or mixture of isomers), naphthylene diamine (any isomer or mixture of isomers) methoxyphenyl-2,4-diamine, 4,4′-biphenylene diamine, 3,3′-dimethoxy-4,4′-biphenyl diamine, 3,3′-dimethyl-4-4′-biphenyl diamine and 3,3′-dimethyldiphenyl methane-4,4′-diamine. Preferred aromatic diamines are phenylene diamine and toluene diamine, and especially preferred are 1,3-phenylene diamine, 2,4-toluenediamine, 2,6-toluenediamine, and mixtures of any two or more thereof.

The imidization reaction is performed in the presence of at most 3 parts, preferably at most 2 parts or at most 1 part by weight of another carboxylic acid anhydride and/or a polycarboxylic acid, per 100 parts by weight of the trimellitic anhydride. Such other carboxylic acid anhydride or polycarboxylic acid, if present at all, may be, for example, an impurity in the trimellitic anhydride. The other carboxylic acid anhydride and/or polycarboxylic acid may be absent. The near- or total absence of the other carboxylic acid anhydride and/or polycarboxylic acid allows a more defined, predictable product to be produced in the imidization reaction.

The trimellitic anhydride and aromatic aminoacid or aromatic diamine, as the case may be, suitably are combined in a ratio that provides 0.8 to 1.2, preferably 0.9 to 1.1 or 0.95 to 1.05 equivalents of anhydride groups per equivalent of amine groups. A preferred ratio is 0.98 to 1.02 or 0.99 to 1.01 anhydride equivalents per equivalent of amine groups.

The trimellilitic anhydride reacts with the aromatic amino acid or aromatic diamine, as the case may be, to form an amic acid intermediate that is subsequently ring-closed/dehydrated by chemical or thermal means to form an aromatic monoimide (in the case of an aminoacid) or an aromatic diimide (in the case of an aromatic diamine), in each case with the evolution of water. The aromatic monoimide is represented by the structure (I), wherein Ar represents an aromatic group, and the aromatic diimide is represented by structure (II) wherein Ar′ represents an aromatic group.

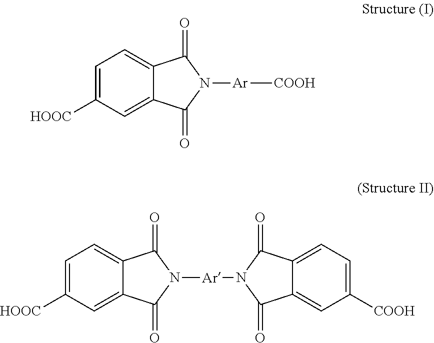

The diimide contains two imide groups and likewise contributes two imide groups to the imide-modified polyol composition of the invention.

The imidization reaction is conveniently performed at a temperature of 20° C. to 180° C. The pressure is not especially critical, being generally sufficient to prevent the reactants from boiling off. Temperature and pressure conditions that permit water evolving in the imidization reaction to evaporate or distill (including azeotropic distillation) and be removed as the reaction proceeds are preferred. It is preferred to pass an inert sweeping gas through the reaction vessel to remove water and/or water-containing azeotrope.

The imidization reaction may be performed in a suitable solvent for the trimellitic anhydride and aromatic aminoacid or aromatic diamine (as the case may be). In some embodiments, the solvent is not reactive with any of the starting materials or the reaction product. Examples of such non-reactive solvents include, for example, N,N-dimethylacetamide, N-methylpyrroldinone, N,N-dimethylformamide, toluene, xylenes, benzene, various C6-C24 hydrocarbons, their mixtures, and the like. The reaction may be performed under reflux conditions for such a non-reactive solvent(s), when used. The imide group-containing compound having terminal carboxylic acid groups produced in the imidization may be isolated from the non-reactive solvent(s) and dried.

Alternatively, the imidization reaction is performed in the presence of the polyol(s) having a hydroxyl equivalent weight of 30 to 500 g/equivalent, in which case the polyol(s) can function as a solvent or reaction medium. When done in the presence of the polyol(s), the imidization reaction should be performed in the absence of an effective amount of an esterification catalyst, i.e., a catalyst for the reaction of an alcohol with a carboxylic acid. In the absence of such a catalyst, little or no esterification of the carboxyl groups occurs during the imidization step. Although the imide group-containing product may be isolated from the polyol(s) and dried, it is generally preferred not to do so, leaving the imide group-containing product in the polyol(s).

The mono- or diimide having terminal carboxylic acid groups obtained in the imidization step is then esterified by reaction with the polyol(s) have a hydroxyl equivalent weight of 30 to 500 g/equivalent. Hydroxyl equivalent weights are measured by titration according to ASTM E1899-16. This method yields a hydroxyl number in mg KOH/g, which is converted to equivalent weight by the relationship Equivalent Weight=56,100÷hydroxyl number. The polyol(s) may be in or include any polyol(s) present during the imidization reaction. Preferably, at least one polyol having a hydroxyl equivalent weight of at least 95 and up to 500 g/equivalent, for example 95 to 400, 95 to 350 or 150 to 250 g/equivalent, is reacted with the mono- or diimide. Such a polyol having a hydroxyl equivalent weight of at least 95 up to 500 in some embodiments constitutes at least 50%, at least 75% or at least 90% of the total weight of the polyol(s) having hydroxyl equivalent weights of 30 to 500 g/equivalent. The polyol having a hydroxyl equivalent weight of at least 95 up to 500 preferably is difunctional and preferably is a polyether, especially polyethylene glycol, poly(propylene glycol) or an ethylene oxide/propylene oxide copolymer diol. Other useful polyols include diols such as ethylene glycol, diethylene glycol, triethylene glycol, 1,2-propane diol, 1,3-propane diol, dipropylene glycol, tripropylene glycol, cyclohexane dimethanol, neopentyl glycol and the like. Polyols having 3 or more hydroxyl groups can form all or part of the polyols having an equivalent weight of 30 to 500, but if used preferably constitute a small proportion thereof, such as up to 20%, up to 10% or up to 5% by weight, so avoid excessive branching and/or crosslinking. Examples of such polyols include glycerin, trimethylolpropane, trimethylolethane, pentaerythritol, erythritol, triethanolamine, and polyethers having 3 to 6 hydroxyl groups per molecule and an equivalent weight of, for example 100 to 500 g/equivalent.

Optionally, in one method the imide group-containing compound(s) having terminal carboxylic acid groups are combined with one or more aromatic dicarboxylic acid derivatives that contain no imide groups selected from aromatic carboxylic acid anhydrides, aromatic dicarboxylic acids, aromatic dicarboxylic acid halides, and aromatic dicarboxylic acid dialkyl esters, and the esterification step is performed simultaneously on the resulting mixture. This aromatic dicarboxylic acid derivative contains no imide groups and preferably has a formula molecular weight of no greater than 250 g/mol.

Examples of such aromatic dicarboxylic acid derivatives include phthalic anhydride, phthalic acid, isophthalic acid, terephthalic acid, trimesic acid, pyromellitic anhydride, dimethyl terephthalate, dimethyl isophthalate, dimethyl phthalate, terephthaloyl chloride, isophthaloyl chloride, phthaloyl chloride, and the like; and mixtures of any two or more thereof. Preferred aromatic dicarboxylic acid derivatives are phthalic anhydride, phthalic acid, isophthalic acid, and especially phthalic anhydride. In such embodiments, the mole ratio of the mono- and/or diimide to the aromatic dicarboxylic acid derivative is at least 25:75, and may be any higher ratio up to 99.99:0.01. Examples of suitable ratios are at least 30:70 or at least 50:50. In specific embodiments this ratio may be up to 95:5, up to 90:10, up to 80:20 or up to 70:30.

Alternatively, the imide group-containing compound having terminal carboxylic acid groups undergoes the esterification step in the absence of an added aromatic dicarboxylic acid derivative to produce an imide-modified polyol. Some of the starting polyol(s) may remain unreacted during this step, in which, an aromatic dicarboxylic acid derivative can subsequently be added and the resulting mixture subjected to esterification and/or transesterification conditions to produce an imide group-containing polyol composition of the invention.

The ratio of polyol(s) to the imidized reaction product is preferably selected to provide 1.5 to 3 equivalents of hydroxyl groups per equivalent of carboxyl groups provided by the mono- or diimide, plus the carboxyl groups provided by aromatic dicarboxylic acid derivative, if any. For purposes of this calculation, an anhydride group is counted as two carboxylic acid groups, and carboxylic acid alkyl ester and halide groups are each counted as one carboxylic acid group. A preferred equivalent ratio is at least 1.6, at least 1.75 or at least 1.9 and up to 2.5, up to 2.25, up to 2.10 or up to 2.05. When the equivalent ratio is greater than about 2, a portion of the polyol usually remains unreacted during the esterification step.

The esterification reaction is conveniently performed in the presence of an esterification catalyst. Examples of esterification catalysts include Bronsted acid such as sulfuric acid, p-tolunesulfonic acid; Lewis acids such as SnCl₄, AlCl₃ and BF₃, tin(II) compounds such as SnCl₂, and various tin dicarboxylates; organotin(IV) compounds such as dialkyltinoxides, dialkyltindicarboxylates and the like, pyrone coordination Sn(II), Pb(II), Zn(II) and/or Hg(II) complexes, and various titanium compounds such as titanium acetylacetonate, titanium(IV)oxyacetylacetonate, titanium diisopropoxidebis) acetylacetonate, tetraisopropyltitanium, triethanolamine titanate, titanium(IV)isobutoxide, as well as other organotitanium and organozirconium catalysts as described in U.S. Pat. No. 3,056,818. Other examples of catalysts useful in the present invention are described, for instance, in U.S. Pat. No. 10,619,000. The catalyst is used in a catalytically effective amount, such as from 10 to 10,000 parts by weight per million parts of the combined weights of the mono- or diimide, polyol(s) and any added aromatic dicarboxylic acid derivative.

The esterification reaction is conveniently performed at a temperature of greater than 100° C. and up to 270° C. A preferred temperature is at least 180° C., at least 200° C. or at least 220° C. The pressure is not especially critical, being generally sufficient to prevent the reactants from boiling off, but temperature and pressure conditions that permit water and other volatile by-products of the esterification reaction to evaporate or distill and be removed as a vapor as the reaction proceeds are preferred. A preferred pressure is approximately atmospheric pressure, such as about 90 to 110 kPa actual. Subatmospheric pressures less than atmospheric pressure to as low as 1 kilopascal can be used. The esterification reaction may be performed in a suitable solvent for the starting materials, such as those described above with respect to the imidization reaction. The reaction may be performed under reflux conditions for the solvent, when used, but it is preferred to perform the esterification reaction in the absence of any solvent apart from the reactants. The reaction preferably is continued until the acid number is reduced to less than 2 mg KOH/g, preferably less than 1 mg KOH/g or less than 0.5 mg KOH/g, as measured by the potentiometric titration with a standardized 0.01 N potassium hydroxide solution. If a portion of the polyol(s) volatilize, it can be replenished by adding a corresponding amount of additional polyol(s) followed by additional reaction under transesterification conditions.

The resulting imide-modified polyol composition includes one or more hydroxyl-terminated, ester-containing reaction products of the imide group-containing compound and the polyol(s). When an aromatic dicarboxylic acid derivative is present during all or part of the esterification step, the composition also contains one or more hydroxyl-terminated ester-containing reaction products of the aromatic dicarboxylic acid derivative and the polyol(s). The imide-modified polyol composition may contain some amount of unreacted starting polyol(s). The imide-modified polyol composition has a hydroxyl number of 150 to 275 mg KOH/g, preferably 150 to 240 mg KOH/g or 150 to 220 mg KOH/g, as measured according to ASTM E1899-16. It contains 0.50 to 1.75 moles of aromatic imide groups per kilogram of imide-modified polyol composition. In specific embodiments the imide-modified polyol composition contains at least 0.6 or at least 0.7 moles of aromatic imide groups per kilogram, and in specific embodiments contains at most 1.6 or at most 1.55 moles of aromatic imide groups per kilogram. An imide-containing compound made by reacting two moles of trimellitic anhydride with a mole of an aromatic diamine produces two moles of imide groups.

The imide-modified polyol composition may have an average hydroxyl functionality in the range from 1.8 to 4, preferably 1.8 to 3 or 1.8 to 2.2. Preferably, the imide-modified polyol composition is a liquid at room temperature. In some cases some crystals may form upon prolonged standing at room temperature; these crystals typically disappear upon heating the imide-modified polyol composition. The imide-modified polyol composition may exhibit a viscosity of, for example, of 1 to 200 Pas, especially 5 to 100 or 5 to 50 Pas, as measured according to ISO3219 at 30° C. and a shear rate of 10 sec-1. If crystals have formed in the imide-modified polyol composition, viscosity is measured by heating the composition to 70° C. to melt out the crystals, cooling to 30° C. within 4 hours, and then determining viscosity.

The glass transition temperature (T_{g}) of the imide-modified polyol composition may be, for example, −10° C. to −80° C., especially −25° C. to −65° C., as measured according to ASTM E1356-08 (2014), taking the midpoint temperature as the T_{g}.

The imide-modified polyol composition is useful for making isocyanate-based polymers. The isocyanate-based polymers contain urethane groups produced in a reaction of hydroxyl groups of the imide-modified polyol composition with isocyanate groups of a polyisocyanate. The isocyanate-based polymer may further contain other groups formed in a reaction of an isocyanate group, such as urea, isocyanurate, biuret, allophanate, carbodiimide and like groups. Of particular interest herein are polyurethane-isocyanurate polymers, particularly foams, that contain urethane and isocyanurate groups, and optionally urea groups as well. Isocyanurate groups are formed in a trimerization reaction of three isocyanate groups.

Rigid isocyanate-based foam is made by forming a reaction mixture and reacting the reaction mixture to produce the rigid isocyanate-based foam. The reaction mixture comprises the imide-modified polyol composition of the invention and at least one aromatic polyisocyanate. The aromatic polyisocyanate is provided in an amount to provide an isocyanate index of 100 to 600. Isocyanate index is 100 times the ratio of isocyanate groups to isocyanate-reactive groups (hydroxyl, primary or secondary amino, carboxylic acid, water, etc.) provided to the reaction mixture. For purposes of calculating isocyanate index, water is considered as having two isocyanate-reactive groups and a primary amino group is considers as only one isocyanate-reactive group. The isocyanate index in some embodiments is at least 125, preferably at least 150, and even more preferably at least 180.

The polyisocyanate may have an isocyanate equivalent weight of up to 300 g/equivalent, for example. The isocyanate equivalent weight may be up to 250, up to 175, and in some embodiments is 80 to 175 g/equivalent. If a mixture of polyisocyanate compounds is used, these equivalent weights apply with respect to the mixture; individual polyisocyanate compounds in such a mixture may have isocyanate equivalent weights above, within or below those ranges.

Examples of useful polyisocyanates include m-phenylene diisocyanate, toluene-2,4-diisocyanate, toluene-2,6-diisocyanate, hexamethylene-1,6-diisocyanate, tetramethylene-1,4-diisocyanate, cyclohexane-1,4-diisocyanate, hexahydrotoluene diisocyanate, naphthylene-1,5-diisocyanate, 1,3- and/or 1,4-bis(isocyanatomethyl)cyclohexane (including cis- and/or trans isomers), methoxyphenyl-2,4-diisocyanate, diphenylmethane-4,4′-diisocyanate, diphenylmethane-2,4′-diisocyanate, hydrogenated diphenylmethane-4,4′-diisocyanate, hydrogenated diphenylmethane-2,4′-diisocyanate, 4,4′-biphenylene diisocyanate, 3,3′-dimethoxy-4,4′-biphenyl diisocyanate, 3,3′-dimethyl-4-4′-biphenyl diisocyanate, 3,3′-dimethyldiphenyl methane-4,4′-diisocyanate, 4,4′,4″-triphenyl methane triisocyanate, polymethylene polyphenylisocyanate (PMDI), toluene-2,4,6-triisocyanate and 4,4′-dimethyldiphenylmethane-2,2′,5,5′-tetraisocyanate. Preferably the polyisocyanate is diphenylmethane-4,4′-diisocyanate, diphenylmethane-2,4′-diisocyanate, PMDI, toluene-2,4-diisocyanate, toluene-2,6-diisocyanate or mixtures thereof. Diphenylmethane-4,4′-diisocyanate, diphenylmethane-2,4′-diisocyanate and mixtures thereof are generically referred to as MDI, and all can be used. “Polymeric MDI”, which is a mixture of PMDI and MDI, can be used. Toluene-2,4-diisocyanate, toluene-2,6-diisocyanate and mixtures thereof are generically referred to as TDI, and all can be used.

The imide-modified polyol composition of the invention constitutes at least 25%, preferably at least 50% by weight of the polyols present in the foam-forming reaction mixture. In some embodiments, the imide-modified polyol composition constitutes at least 60% or at least 70% of the total weight of all polyols. It may constitute up to 100%, up to 95%, up to 90% or up to 80% of the total weight of all polyols. The polyols in the foam-forming reaction mixture optionally contain one or more non-imide-modified polyols, provided the imide content of the polyols is 0.125 to 1.75 moles, especially 0.25 to 1.75 moles, and even more preferably 0.40 to 1.50 moles, of imide groups per kilogram of the combined weight weight of all polyols. The non-imide-modified polyol(s), if present, may constitute, for example, 1 to 75%, 1 to 50%, 1 to 40%, 1 to 30%, 1 to 20%, 1 to 10% or 1 to 5% of the total weight of all polyols (including the imide-modified polyol composition of the invention).

The non-imide-modified polyol(s) useful for the foam-forming reaction mixture of the present invention may have, for example, an average nominal hydroxyl functionality in the range 1.8 to 8, preferably 1.8 to 6.0, more preferably 1.8 to 3.0, and an average hydroxyl number of 75 mg to 350 mg KOH/g.

Non-imide-modified polyols, if present, may include, for example, chain extenders, i.e., compounds that react difunctionally with isocyanate groups and have equivalent weights per isocyanate-reactive group of less than 200, preferably 30 to 125. Examples of chain extenders include ethylene glycol, diethylene glycol, triethylene glycol, propylene oxide, dipropylene glycol, tripropylene glycol, 1,4-butanediol, 1,6-hexanediol, ethylene diamine, propylene diamine, and the like.

Other non-imide-modified polyols may include crosslinkers, i.e., compounds that have three or more isocyanate-reactive groups and equivalent weights per isocyanate-reactive group of less than 200, preferably 30 to 125. Examples of crosslinkers include glycerin, trimethylolpropane, triethylolpropane, pentaerythritol, erythritol, triethanolamine, diethanolamine, mannitol, sucrose, urea, sorbitol and the like.

Other useful non-imide-modified polyols include polyether polyols having an equivalent weight per isocyanate-reactive group of greater than 125 g/equivalent. The equivalent weight may be, for example, up to 2000, up to 1000, up to 500, up to 400 or up to 300 g/equivalent. These polyols may have an average of 2 to 8, 2 to 4 or 2.5 to 4 isocyanate-reactive groups per molecule. Polyether polyols include, for example, homopolymers of propylene oxide and random polymers of at least 70 mole-% propylene oxide and up to 30 mole-% ethylene oxide, and homopolymers of ethylene oxide, random and/or block copolymers of at least 50 mole-% ethylene oxide at least and up to 50 mole-% of propylene oxide and/or butylene oxide.

Still other useful non-imide-modified polyols include polyester polyols and polycarbonate polyols. Non-imide-modified polyols when present preferably include at least one aromatic polyester polyol not present in the imide-modified polyol composition of the invention. Such an aromatic polyester polyol may have a hydroxyl equivalent weight of, for example, 150 to 400 g/equivalent and a hydroxyl functionality of 2 to 3, especially 2 to 2.7 or 2 to 2.5. When present, such other aromatic polyester polyol may constitute, for example, at least 5% or at least 10% and up to 75%, up to 35% or up to 25% of the total weight of all polyols.

The polyols present in the foam-forming reaction mixture preferably contain no more than 45%, no more than 30%, no more than 25%, no more than 15% or no more than 10% by weight of polyether polyols (other than the imide-modified polyol composition). In particular, polyether polyols having hydroxyl functionalities greater than 3 preferably constitute no more than 10% or no more than 5% of the total weight of all polyols, and are more preferably absent.

In some embodiments, a polyethylene glycol having a number average molecular weight of up to 400 g/mol constitutes 1 to 30% of the total weight of all polyols.

The foam-forming reaction mixture contains at least one blowing agent. The blowing agent may be or include a chemical blowing agent that reacts under the conditions of the foaming reaction to produce a gas. Examples of chemical blowing agents include water and formic acid, with water being an especially preferred chemical blowing agent. In preferred embodiments, the foam-forming reaction mixture contains water in an amount of 0.1 to 3, or 0.2 to 2.5, or 0.5 to 2.5, especially 0.8 to 2.0 parts by weight per 100 parts of total polyols in the foam-forming reaction mixture.

The blowing agent may be or include one or more physical (endothermic) blowing agents, which can be used alone or in combination with one or more chemical blowing agents (especially water). Examples of physical blowing agents include methyl formate, various low boiling hydrocarbons (e.g., heptane, hexane, n-pentane, iso-pentane, butane, cyclopentane, cyclohexane, and the like; and mixtures thereof), various low boiling ketones such as acetone and methyl ethyl ketone, various hydrochlorofluorocarbons (HCFCs) such as 1,1-dichloro-1-fluoroethane, various hydrofluorocarbons (HFCs) such as 1,1,1,3,3-pentafluoropropane, various hydrofluoroolefins (HFOs) such as trans-1,3,3,3-tetrafluoroprop-1-ene, 1,3,3,3-tetrafluoropropene, and the like; and mixtures thereof. Some commercially available hydrofluoroolefin blowing agents include Solstice® LBA and Solstice® GBA, available from Honeywell; and Opteon™ 1100 and Opteon™ 1150, available from Chemours. Linear, branched and/or cyclic C₄-C₆ alkanes such as cyclopentane, isopentane, n-pentane and neopentane are particularly useful. A particularly preferred physical blowing agent is n-pentane or a cyclopentane/isopentane blend. Physical blowing agent(s), when present, may be present in an amount of 0.1 to 40 parts by weight per 100 parts of total polyols in the foam-forming reaction mixture.

The foam-forming reaction mixture contains at least one halogenated and/or phosphorus-containing flame retardant, which preferably is not reactive toward isocyanate groups. Suitable examples of non-reactive phosphorus-containing flame retardants include tris(1-chloropropyl)phosphate, triethylphosphate, resorcinol bis(diphenyl phosphate), triphenyl phosphate, trimethyl phosphate, triphenylphosphine oxide, 9,10-dihydro-9-oxa-10-phosphaphenanthrene-10 oxide and derivative, red phosphorus, inorganic phosphinates, aluminum phosphate, melamine orthophosphate, dimelamine orthophosphate, melamine pyrophosphate, melamine polyphosphate, oligomeric ethyl ethylene phosphate, dimethyl methylphosphonate, diethyl ethylphosphonate, diethyl propylphosphonate, tris (2-chloroethyl) phosphate, cyclic phosphonates, pentaerythrtol phosphonate, cyclic neopentyl thiophosphoric anhydride, metal phosphinic acid salts such as zinc diethyl phosphinate and aluminum diethyl phosphinate, tricresyl phosphate, t-butylphenyl phosphates including t-butylphenyl diphenyl phosphate, 2-ethylhexyl diphenyl phosphate, isodecyl diphenyl phosphate, and varous phosphazene compounds. Polymeric or oligomeric phosphorus-containing compounds such as oliogomeric alkyl phosphate ester (e.g., Levagard® 2000 and Levagard® 3000, from Lanxess) are also suitable. Phosphorus flame retardants containing one or more hydroxyl groups can also be used, for example, Levagard® 2100 and Levagard® 4090N from Lanxess, Fyrol 6® and VeriQuel™ R100 from ICL Industrial Products. It is preferred to omit halogenated flame retardants. When used, the flame retardant may be present in an amount of from 0.1 to 30 parts, 1 to 25 parts, 2 to 25 parts, or 5 to 25 parts, per 100 parts by weight of total polyols amount in the foam-forming reaction mixture.

The foam-forming reaction mixture includes at least one foam-stabilizing surfactant. The foam-stabilizing surfactant helps stabilize the gas bubbles formed by the blowing agent during the foaming process until the polymer has cured. Examples of suitable surfactants include silicone-based surfactants such as polysiloxane polyoxylalkylene blockcopolymers disclosed in U.S. Pat. Nos. 2,834,748, 2,917,480, and 2,846,458; and organic-based surfactants containing polyoxyethylene-polyoxybutylene block copolymers such as those described in U.S. Pat. No. 5,600,019. Examples of such silicone surfactants are commercially available under the trade names Tegostab™ (Evonik Industries AG), Niax™ (Momentive), Vorasurf® (Dow Chemical) and Dabco™ (Air Products and Chemicals). Specific examples of useful surfactants include VORASURF™ DC 193, VORASURF™ RF 5374, VORASURF™ DC 5604, VORASURF™ SF 2937, VORASURF™ DC 5098, VORASURF™ 504, TEGOSTAB® B8418, TEGOSTAB® B8491, TEGOSTAB® B8421, TEGOSTAB® B8461, and TEGOSTAB® B8462, NIAX* L-6988, NIAX* L-6642, and NIAX* L-6633 surfactants. The amount of surfactant, when used, may be from 0.1 to 10.0 parts per 100 parts of total polyols present in the foam-forming reaction mixture.

The foam-forming reaction mixture contains one or more catalysts. The catalysts may include one or more urethane catalysts, by which it is meant compounds that catalyze either or both of the water-isocyanate reaction and the alcohol-isocyanate reaction. Suitable catalysts include, for example, including tertiary amines, cyclic amidines, tertiary phosphines, various metal chelates, acid metal salts, strong bases, various metal alcoholates and phenolates and metal salts of organic acids. Examples of metal-containing catalysts are tin, bismuth, cobalt and zinc salts. Catalysts of most importance are tertiary amine catalysts, cyclic amidines, zinc catalysts and tin catalysts. Examples of tertiary amine catalysts include: trimethylamine, triethylamine, tributylamine, N-methylmorpholine, N-ethylmorpholine, N,N-dimethylbenzylamine, N,N-dimethylethanolamine, N,N-dimethylaminopropylamine, N,N,N′,N′-tetramethyl-1,4-butanediamine, N,N,N′,N′-tetramethylethylenediamine, N, N,N′,N″, N″, pentamethyldiethylene-triamine, N,N-Dimethylcyclohexylamine, N,N-dimethylpiperazine, 1,4-diazobicyclo-2,2,2-octane, bis(dimethylaminoethyl)ether, triethylenediamine and dimethylalkylamines where the alkyl group contains from 4 to 18 carbon atoms. Mixtures of these tertiary amine catalysts are often used. When used, tertiary amine catalysts may be present, for example, in an amount of from 0.05 to 5 parts per on 100 parts by weight of polyols in the foam-forming reaction mixture.

Examples of metal-containing urethane catalysts include tin (II) salts of organic carboxylic acids such as tin (II) diacetate, tin (II) ricinoleate or tin (II) dioctoate, bismuth salts of organic carboxylic acids such as bismuth octanoate); organotin compounds such as dimethyltin dilaurate, dibutyltin dilaurate, and other tin compounds of the formula SnRₙ(OR)₄₋ₙ, wherein R is alkyl or aryl and n is 0 to 18, and the like; dialkyl tin mercaptoates, and the like. Metal-containing urethane catalysts are generally used in amounts such as 0.0015 to 0.25 parts by weight per 100 parts total polyols present in the foam-forming reaction mixture.

A reactive amine catalyst such as DMEA (dimethylethanolamine) or DMAPA (dimethylaminopropyl amine), or an amine-initiated polyol, acting as an autocatalytic polyol, may also be used to reduce VOC's (volatile organic compounds).

The foam-forming reaction mixture preferably contains at least one isocyanate trimerization catalyst. The isocyanate trimerization catalyst is a material that promotes the reaction of isocyanate groups with other isocyanate groups to form isocyanurate rings. Useful isocyanate trimerization catalysts include strong bases such as alkali metal phenolates, alkali metal alkoxides, alkali metal hydroxides, alkali metal carboxylates, quaternary ammonium salts and the like. The alkali metal is preferably sodium or potassium. Specific examples of such trimerization catalysts include sodium p-nonylphenolate, sodium p-octyl phenolate, sodium p-tert-butyl phenolate, sodium acetate, sodium 2-ethylhexanoate, sodium propionate, sodium butyrate, the potassium analogs of any of the foregoing, trimethyl-2-hydroxypropylammonium carboxylate salts, N,N′,N″-tris(3-dimethylaminopropyl) hexahydro-S-triazine, and the like. The isocyanate trimerization catalyst may be present in a catalytic quantity, such as 0.05 to 10 parts by weight per 100 parts of total polyols present in the foam-forming reaction mixture.

In addition to the foregoing components, the foam formulation may contain various other optional ingredients such as, for example, liquid nucleating additives, solid nucleating agents, Ostwald ripening inhibitor additives, reactive or non-reactive diluents, expandable graphite, pigments, rheological modifiers, emulsifiers, antioxidants, mold release agents, dyes, pigments and/or colorants such as titanium dioxide, iron oxide, chromium oxide, azo/diazo dyes, phthalocyanines, dioxazines and carbon black; fillers or reinforcing agents such as fiber glass, carbon fibers, flaked glass, mica, talc and the like; and mixtures thereof.

Foam is prepared by combining the polyol(s), blowing agent(s), polyisocyanate(s), surfactant(s) and catalysts in the presence of the various optional ingredients (if any) to form a foam-forming reaction mixture. The surfactant, catalysts, blowing agent(s) and various polyols all can be mixed together before they are combined with the polyisocyanate. Alternatively, they can be combined with the polyisocyanate individually (i.e., as separate streams), or can be formed into any sub-mixtures that are then combined with the polyisocyanate. The components can be mixed at a temperature of, for example, 5 to 80° C. The components may be mixed together using equipment such as a spray apparatus, a high pressure impingent mixer, a static mixer, a liquid dispensing gun or a mixing head, or a stirred vessel.

The reaction mixture is then reacted to form a foam. The process of this invention requires no special processing conditions; therefore, general processing conditions and equipment described in the art for making rigid isocyanate-based foam are entirely suitable. In general, the components of the reaction mixture are combined and the fully mixed foam-forming reactive composition is subjected to conditions sufficient to allow the foaming reaction to occur. In most cases the isocyanate compounds will react spontaneously with the chemical blowing agent (if present) and the polyols even at room temperature (22° C.). If necessary, heat can be applied to the reaction mixture to speed the curing reaction. This can be done by heating some or all of the ingredients prior to combining them, by applying heat to the reaction mixture, or some combination of each. The curing temperature may be, for example, 20° C. to 150° C. or 30° C. to 80° C. Curing is continued until the reaction mixture has expanded and cured sufficiently to form a stable foam.

In some embodiments, the curing step is performed in a closed mold. In such a process, the reaction mixture is either formed in the mold itself, or formed outside the mold and then injected into the mold, where it cures. The expansion of the reaction mixture as it cures is therefore constrained by the internal surfaces of the mold, as are the size and geometry of the molded part.

In other embodiments, the curing step is performed in a free-rise (or slabstock) process. In the free-rise process, the reaction mixture is poured into an open container such that expansion in at least one direction (usually the vertical direction) occurs against the atmosphere or a lightweight surface (such as a film) that provides negligible resistance to the expansion of the foam. In the free-rise process, the reaction mixture expands in at least one direction essentially unconstrained except by its own weight. The free-rise process may be performed by forming the reaction mixture and dispensing it into a trough or onto a conveyor where it expands and cures.

In still other embodiments, the foam-forming reaction mixture is dispensed between facing panels (or atop a single panel), gauged into a layer and cured to form a laminated material. This can be performed, for example, on a double belt laminator or similar equipment. Curing is conveniently performed by passing the facing panel(s) with applied foam-forming reaction mixture layer through an oven which supplies heat to promote curing. This process is useful for producing sandwich panels for the construction or transportation industries.

The cured foam in some embodiments has a foam density of 20 to 200 kg/m³, preferably 25 to 150 kg/m³ and more preferably 25 to 100 kg/m³, as measured by ISO 3886.

The cured foam of the invention may exhibit a limiting oxygen index of at least 27%, such as 27 to 32% or 27 to 30%, as measured according to ASTM D2863.

The cured foam in some embodiments exhibits a thermal conductivity or k-factor (10° C. average plate temperature) of 13 to 30 mW/m-K. In some embodiments the k-factor is at least 14 or at least 15 mW/m-K and is at most 26, at most 23 or at most 20 mW/m-K. In some embodiments, a reduction in k-factor is seen with this invention, compared to an otherwise like foam in which the imide-modified polyol composition of the invention is replaced with a non-imide-modified, phthalic anhydride-based polyol.

Foam of the invention is useful in various types of thermal insulation applications such as for building and construction use, walk-in cooler, refrigerated transport container, cryogenic storage, and the like applications.

The imide-containing polyols can also be used to make non-cellular isocyanate-based polymers useful in, for example, coatings, adhesives, and electronics, etc.

The following examples are provided to illustrate the invention, but are not intended to limit the scope thereof. All parts and percentages are by weight unless otherwise indicated.

### EXAMPLE P1

Step 1:72.02 grams (0.5252 mole) of 4-aminobenzoic acid are dissolved in 525 mL of N,N-dimethylacetamide in a flask under nitrogen. 100.89 grams (0.5252 mole) of trimellitic anhydride (TMA) are added in 4 equal portions of equal mass over 40 minutes and then stirred for another hour. 80 mL of toluene are added. A trap and condenser are attached to the apparatus. Under a nitrogen sweep, the reaction mixture is brought to reflux for 4 hours, with distilled water being condensed and drained from the trap. The toluene is subsequently distilled and drained from the trap. The reaction mixture is then cooled. Product 4-carboxylphenyltrimellitimide, which crystallizes upon cooling, is collected by filtration and dried to constant weight in a 110° C. vacuum oven. The collected product has a melting point of 376° C. and has the structure:

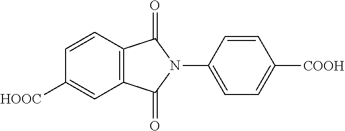 [SMILES: O=C(O)c1ccc(N2C(=O)c3ccc(C(=O)O)cc3C2=O)cc1]

Step 2:175 grams (0.56223 mole) of the 4-carboxyphenyltrimellitimide are charged to a flask with 17.9 g (0.1687 mole) of diethylene glycol (DEG) and 192.1 grams (0.9557 mole) of a 201 Mₙ polyethylene glycol (PEG 200). Under nitrogen, the stirred reaction mixture is degassed, then heated over 1.6 hours to 200° C. 0.0875 grams of a titanium esterification catalyst (TYZOR AA105, from Dorf Ketal) are added when the temperature reaches 102° C. The reaction mixture is maintained at 200° C. for 1 hours, raised to 210° C. and held at that temperature for 3 hours, and then raised again to 220° C. for 4 hours while collecting distillate (mainly water, with some diethylene glycol). The reaction temperature is reduced to 200° C. and 5.38 grams of make-up diethylene glycol are added. The reaction mixture is then heated at 180° C. for 1 hour and cooled. The resulting product, IMPC (Imide-Modified Polyol Composition) P1, has a hydroxyl number of 167 mg KOH/g, an acid number of 0.59 mg KOH/g, and a glass transition temperature of −32° C. It contains approximately 1.54 moles of imide groups per kilogram.

### Example P2

40.51 g (0.1301 mole) of 4-carboxyphenyltrimellitimide and 19.28 g (0.1301 mole) of phthalic anhydride are combined and reacted with 88.94 g (0.4425 mole) of PEG 200 and 8.29 g (0.0781 mole) diethylene glycol and 0.0167 grams of TYZOR AA105 in a manner analogous to step 2 of Example P1. 2.6 grams of make-up diethylene glycol are added before the final heating step at 180° C., to replace the diethylene glycol that volatilizes in the preceding heating step. The resulting product, IMPC P2, has a hydroxyl number of 238 mg KOH/g, an acid number of 0.47 mg KOH/g, and a glass transition temperature of −42° C. It contains approximately 0.87 mole of imide groups per kilogram. Its viscosity at 30° C. is 9.15 Pa·s.

### Example P3

Step 1:500 mL of N,N-dimethylacetamide are dried by refluxing it with 75 mL of toluene in an apparatus as described in Example P1. 50 mL of toluene are removed. 32.44 g (0.3 moles) of 1,3-phenylene diamine are added to the reaction vessel and dissolved under nitrogen. 115.28 grams (0.6 mole) of trimellitic anhydride (TMA) are added in 4 equal portions of equal mass over 75 minutes and then stirred overnight at about 23° C. 50 mL of toluene are added and the reaction mixture brought to reflux for 4.5 hours. Distilled water is condensed and drained from the trap. The toluene is subsequently distilled and drained from the trap. The reaction mixture is then cooled. The product, which crystallizes upon cooling, is collected by filtration, and dried to constant weight in a 110° C. vacuum oven. The collected product has a melting point of 408° C. and has the structure:

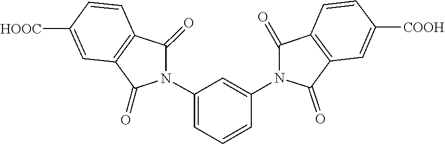 [SMILES: O=C(O)c1ccc2c(c1)C(=O)N(c1cccc(N3C(=O)c4ccc(C(=O)O)cc4C3=O)c1)C2=O]

Step 2:98 grams (0.2147 mole) of the product of step 1 and 31.81 g (0.2147 mole) of phthalic anhydride are charged to a flask with 172.65 g (0.8589 mole) of PEG 200. Under nitrogen, the reaction mixture is degassed, then heated over 1.7 hours to 200° C. 0.1087 grams of a titanium esterification catalyst (TYZOR AA105, from Dorf Ketal) are added when the temperature reaches 81° C. The reaction mixture is maintained at 200° C. for 1 hour, raised to 210° C. and held at that temperature for 3 hours and then raised again to 220° C. for 4 hours while collecting distallate (mainly water). The resulting product, IMPC P3, has a hydroxyl number of 166 mg KOH/g, an acid number of 0.27 mg KOH/g and a glass transition temperature of −33° C. It contains approximately 1.48 moles of imide groups per kilogram. Its viscosity at 30° C. is 68.4 Pa·s.

### Example P4

In an apparatus similar to that described in Example P1, 167.88 g (0.8352 mole) PEG 200, 15.64 g (0.1474 mole) diethylene glycol and 50.54 g (0.3685 mole) 4-aminobenzoic acid are combined under nitrogen. The stirred mixture is degassed and a nitrogen sweep started. The reaction mixture is heated to 60° C. to form a clear solution. A total of 70.80 grams (0.3685 mole) of trimellitic anhydride are added in two equal portions over 15 minutes. The reaction mixture is heated to 150° C., held at that temperature for 2 hours, then heated to 175° C. for 2 more hours before being cooled to room temperature. Under these conditions, which include the absence of an esterification catalyst, the imide-forming reaction proceeds with little or no esterification of the carboxyl groups by the PEG 200 or diethylene glycol.

The esterification reaction is then performed. Under nitrogen, the reaction mixture is heated over 1.7 hours to 200° C. 0.1048 grams of a titanium esterification catalyst (TYZOR AA105, from Dorf Ketal) are added when the temperature reaches 100° C. The reaction mixture is maintained at 200° C. for 2 hours, raised to 210° C. and held at that temperature for 2 hours and then raised again to 220° C. for 4 hours while collecting distillate (mainly water). The reaction temperature is reduced to 65° C. At that temperature, 18.19 grams (0.1228 mole) of phthalic anhydride and 0.0404 additional grams of the esterification catalyst are added. The reaction mixture is heated to 220° C. over 35 minutes and held at that temperature another 3 hours while collecting distillate. The reaction mixture is cooled to 200° C. and 3.0 grams of make-up diethylene glycol are added. The reaction mixture is cooled to 180° C. and held at that temperature another hour, then cooled. The resulting product, IMPC P4, has a hydroxyl number of 176 mg KOH/g, an acid number of 0.31 mg KOH/g, and a glass transition temperature of −36° C. It contains approximately 1.23 moles of imide groups per kilogram. Its viscosity at 30° C. is 39.9 Pa·s

### Examples P5-P6

IMPC P5 and IMPC P6 are prepared in the same general manner as IMPC P4, by changing the ratios of starting materials as shown in Table 1. Various properties of these polyols are as reported in Table 1.

TABLE 1

| | Parts by Weight (moles) | | | |
|---|---|---|---|---|
| Ingredient | IMPC P5 | | IMPC P6 | |
| Trimellitic Anhydride | 91.69 | (0.4772) | 57.64 | (0.3) |
| p-Aminobenzoic Acid | 65.44 | (0.4772) | 41.14 | (0.3) |
| Phthalic Anhydride | 70.68 | (0.4772) | 103.68 | (0.7) |
| PEG 200 | 326.23 | (1.623) | 341.70 | (1.7) |
| DEG (first addition) | 30.41 | (0.2865) | 31.84 | (0.3) |

| | | |
|---|---|---|
| DEG (make-up) | 10.2 | 15.2 |
| TYZOR AA105 | 0.0995 + 0.0867 | 0.0815 + 0.0801 |
| OH value, mg KOH/g | 200 | 217 |
| Acid value, mg KOH/g | 0.07 | 0.38 |
| Tg, ° C. | −42 | −46 |
| Viscosity, 30° C., Pa · s | 8.8 | 3.0 |
| Moles imide groups/kg | 0.87 | 0.55 |

### Examples P7 and P8

IMPC P7 and IMPC P8 are made in the same general manner as IMPC P4, by substituting m-phenylene diamine for the 4-aminobenzoic acid used to produce IMPC P4, and by varying the ratios of starting materials as shown in Table 2. No diethylene glycol is used in making these polyols. Various properties of these polyols are as reported in Table 2.

TABLE 2

| | Parts by Weight (moles) | | | |
|---|---|---|---|---|
| Ingredient | IMPC P7 | | IMPC P8 | |
| Trimellitic Anhydride | 156.03 | (0.8121) | 102.40 | (0.5330) |
| m-Phenylene Diamine | 43.91 | (0.4060) | 28.82 | (0.2665) |
| Phthalic Anhydride | 60.14 | (0.4060) | 92.10 | (0.6218) |
| PEG 200 | 326.48 | (1.624) | 357.09 | (1.7765) |

| | | |
|---|---|---|
| TYZOR AA105 | 0.0725 + 0.0727 | 0.0788 + 0.0866 |
| OH value, mg KOH/g | 159 | 176 |
| Acid value, mg KOH/g | 0.24 | 0.18 |
| Tg, ° C. | −31 | −35 |
| Viscosity, 30° C., Pa · s | 153 | 16.0 |
| Moles imide groups/kg | 1.48 | 0.97 |

### Example P9

IMPC P9 is made in the same general manner as IMPC P7 and IMPC P8, by substituting 2,4-toluene diamine for the m-phenylene diamine used to produce IMPC P7 and IMPC P8, and by varying the ratios of starting materials as shown in Table 3. No diethylene glycol is used in making these polyols. Various properties of these polyols are as reported in Table 3.

TABLE 3

| Ingredient | Parts by Weight (moles) | |
|---|---|---|
| Trimellitic Anhydride | 163.52 | (0.8509) |
| 2,4-Toluene Diamine | 51.99 | (0.4256) |
| Phthalic Anhydride | 63.03 | (0.4256) |
| PEG 200 | 342.15 | (1.7022) |

| | |
|---|---|
| TYZOR AA105 | 0.0890 + 0.0826 |
| OH value, mg KOH/g | 161 |
| Acid value, mg KOH/g | 0.4 |
| Tg, ° C. | −35 |
| Viscosity, 30° C., Pa · s | 157 |
| Moles imide groups/kg | 1.46 |

### Foam Examples 1-4 and Comparative Foams A and B

Foams are made from formulations as set forth in Table 4. In all cases, the polyols, surfactant, water and catalysts are combined using a laboratory mixer. The imide-containing polyol composition is generally placed in an oven at 70° C. overnight, then mixed with other polyols at room temperature while it is still warm and thereafter cooled to room temperature (18-25° C.). The physical blowing agent (pentane mixture) is then mixed in, followed by the polyisocyanate. The resulting reaction mixture is mixed at high speed for 5 seconds and then immediately poured into a vertically oriented 30 cm×20 cm×5 cm mold which is preheated to 55° C. The reaction mixture is permitted to react in the mold for 20 minutes, at which time the resulting foam is demolded.

Specimens of the fresh foam are conditioned overnight in room temperature air before being taken for property testing. Results of the property testing are as indicated in Table 5. Cream time is observed visually. Gel time is evaluated by touching the surface of the curing reaction mixture periodically with a wood tongue depressor. The gel time is the time after the polyisocyanate and formulated polyol composition are mixed at which strings begin to form when the wood tongue depressor is pulled away. Tack-free time is the time at which the surface of the foam is no longer tacky to the touch.

Free rise foam density is measured according to ASTM D 6226.

k-Factor is measured according to ASTM C518.

Compressive strength is measured according to ASTM D1621.

Limiting oxygen index (LOI) is measured according to ASTM D2863.

Polyester A is an aromatic polyester polyol having a functionality of 2.0 and a hydroxyl number of 220 mg KOH/g.

Polyester B is an aromatic polyester polyol having a functionality of 2.4 and a hydroxyl number of 315 mg KOH/g.

Polyether A is a polyether polyol prepared by alkoxylating glycerin with a mixed feed of ethylene oxide and propylene oxide at roughly a 2:1 weight ratio. It has a functionality of 3 and a hydroxyl number of 374 mg KOH/g.

TEP is triethyl phosphate, a flame retardant.

The Urethane Catalyst is a commercially available 1,1,4,7,7-pentamethyldiethylenetriamine product.

The Trimerization Catalyst is a commercially available solution of 70% potassium acetate in 30% diethylene glycol.

The Pentane Blend is an 80/20 mixture of cyclopentane and isopentane.

The PMDI is a polymeric MDI product having an average isocyanate functionality of 3.0 and an isocyanate equivalent weight of 136.5.

TABLE 4

| Ingredient | A* | B* | Ex. 1 | Ex. 2 | Ex. 3 | Ex. 4 |
|---|---|---|---|---|---|---|
| IMPC P1 | 0 | 0 | 61 | 0 | 0 | 0 |
| IMPC P3 | 0 | 0 | 0 | 61 | 0 | 0 |
| IMPC P4 | 0 | 0 | 0 | 0 | 61 | 0 |
| IMPC P5 | 0 | 0 | 0 | 0 | 0 | 61 |
| Polyester A | 61 | 61 | 0 | 0 | 0 | 0 |
| Polyester B | 20.2 | 20.2 | 20.2 | 20.2 | 20.2 | 20.2 |
| TEP | 15 | 15 | 15 | 15 | 15 | 15 |
| Trimerization Catalyst | 1.8 | 1.8 | 1.8 | 1.8 | 1.8 | 1.8 |
| Urethane Catalyst | 0.95 | 0.95 | 0.95 | 0.95 | 0.95 | 0.95 |
| Silicone Surfactant | 3 | 3 | 3 | 3 | 3 | 3 |
| Pentane Blend | 17 | 18.9 | 17 | 17 | 17 | 17 |
| Water | 0.8 | 0.88 | 0.8 | 0.8 | 0.8 | 0.8 |
| PMDI (index) | 250 (415) | 288 (470) | 250 (395) | 250 (475) | 250 (465) | 250 (435) |
| Moles imide groups/kg | 0 | 0 | 1.16 | 1.11 | 0.92 | 0.65 |
| polyols | | | | | | |

TABLE 5

| Property | A* | B* | Ex. 1 | Ex. 2 | Ex. 3 | Ex. 4 |
|---|---|---|---|---|---|---|
| Cream time, | 10 | 10 | 15 | 9 | 9 | 9 |
| sec | | | | | | |
| Gel time, | 37 | 47 | 84 | 37 | 37 | 38 |
| sec | | | | | | |
| Tack Free | 76 | 130 | 180 | 90 | 85 | 85 |
| Time, sec | | | | | | |
| Core | 43.2 | 44.4 | 42.7 | 41.5 | 42.9 | 43.0 |
| Density, g/L | | | | | | |
| 10° C. K | 19.8 | 20.3 | 19.8 | 19.0 | 19.2 | 18.9 |
| factor, | | | | | | |
| mW/m-K | | | | | | |
| Compressive | 122 | 153.7 | 117 | 110 | 113 | 115 |
| Strength, | | | | | | |
| kPa | | | | | | |
| LOI, % | 27.4 | 27.4 | 28.1 | 27.9 | 28.2 | 27.6 |

The presence of imide groups is shown to increase LOI in the examples of the invention.

### Examples 5-7 and Comparative Foams C-E

Foams are made from formulations as set forth in Table 6 using the general procedure described in the previous examples. “PEG 200” is a 200 number average molecular weight polyethylene glycol. Property testing is also performed in the same manner as described in the previous examples. Results are as indicated in Table 7.

TABLE 6

| | Parts By Weight | | | | | |
|---|---|---|---|---|---|---|
| Ingredient | C* | Ex. 5 | D* | Ex. 6 | E* | Ex. 7 |
| IMPC P1 | 0 | 61 | 0 | 61 | 0 | 0 |
| IMPC P5 | 0 | 0 | 0 | 0 | 0 | 41 |
| Polyester A | 61 | 0 | 61 | 0 | 41 | 0 |
| Polyester B | 20.2 | 20.2 | 20.2 | 20.2 | 20.2 | 20.2 |
| PEG 200 | 0 | 0 | 0 | 0 | 20 | 20 |
| TEP | 20 | 20 | 25 | 25 | 7.5 | 7.5 |
| Trimerization | 1.8 | 1.8 | 1.8 | 1.8 | 1.8 | 1.8 |
| Catalyst | | | | | | |
| Urethane | 0.95 | 0.95 | 0.95 | 0.95 | 0.95 | 0.95 |
| Catalyst | | | | | | |
| Silicone | 3 | 3 | 3 | 3 | 3 | 3 |
| Surfactant | | | | | | |
| Pentane | 17 | 17 | 17 | 17 | 17 | 17 |
| Blend | | | | | | |
| Water | 0.8 | 0.8 | 0.8 | 0.8 | 0.8 | 0.8 |
| PMDI (index) | 245 (405) | 245 (465) | 240 (400) | 240 (460) | 250 (325) | 250 (335) |
| Moles imide | 0 | 1.16 | 0 | 1.16 | 0 | 0.44 |
| groups/kg | | | | | | |
| polyols | | | | | | |

TABLE 7

| Property | C* | Ex. 5 | D* | Ex. 6 | E | Ex. 7 |
|---|---|---|---|---|---|---|
| Cream time, sec | 10 | 12 | 9 | 7 | 11 | 12 |
| Gel time, sec | 37 | 63 | 36 | 37 | 32 | 35 |
| Tack Free Time, sec | 100 | 135 | 95 | 85 | 75 | 165 |
| Core Density, g/L | 44.0 | 43.2 | 43.8 | 42.1 | 45.2 | 46.0 |
| 10° C. K factor, | 19.9 | 20.1 | 20.2 | 19.5 | 19.3 | 19.4 |
| mW/m-K | | | | | | |
| Compressive | 134 | 130 | 97 | 108 | 181 | 204 |
| Strength, kPa | | | | | | |
| LOI, % | 28.6 | 29.4 | 29.8 | 30.3 | 25.0 | 25.4 |

As shown in the data in Table 7, the presence of the imide groups increases LOI at each of the TEP loadings tested.

### Example 8 and Comparative Foam F

Foams are made from formulations as set forth in Table 8 using the general procedure described in the previous examples. “TCPP” is tris(chlorophenyl)phosphate, a flame retardant additive. Property testing is also performed in the same manner as described in the previous examples. Results are as indicated in Table 9.

TABLE 8

Parts by Weight

| Ingredient | F* | Ex. 8 |
|---|---|---|
| IMPC P1 | 0 | 61 |
| Polyester A | 61 | 0 |
| Polyester B | 20.2 | 20.2 |
| TCPP | 15 | 15 |
| Trimerization Catalyst | 1.8 | 1.8 |
| Urethane Catalyst | 0.95 | 0.95 |
| Silicone Surfactant | 3 | 3 |
| Pentane Blend | 17 | 17 |
| Water | 0.8 | 0.8 |
| PMDI (index) | 250 (415) | 250 (460) |
| Moles imide groups/kg polyols | 0 | 1.16 |

TABLE 9

| Property | F* | Ex. 8 |
|---|---|---|
| Cream time, sec | 10 | 22 |
| Gel time, sec | 48 | 80 |
| Tack Free Time, sec | 80 | 140 |
| Core Density, g/L | 43.8 | 42.4 |
| 10° C. K factor, mW/m-K | 19.4 | 20.1 |
| Compressive Strength, kPa | 114.5 | 125.5 |
| LOI, % | 25.8 | 29.2 |

A very large increase in LOI is seen with the imide-modified polyol of the invention, when TCPP is used as the flame retardant.

### Example 9

Foam is made from the formulation set forth in Table 10 using the general procedure described in the previous examples. Property testing is also performed in the same manner as described in the previous examples. Results are as indicated in Table 11; results for Comparative Sample C are included for comparison.

TABLE 10

| | Parts by Weight |
|---|---|
| Ingredient | Ex. 9 |
| IMPC P9 | 52.8 |
| Polyether A | 28.4 |
| TEP | 20 |
| Trimerization Catalyst | 1.8 |
| Urethane Catalyst | 0.95 |
| Silicone Surfactant | 3 |
| Pentane Blend | 17 |
| Water | 0.8 |
| PMDI (index) | 245 (405) |
| Moles imide groups/kg polyols | 1.16 |

TABLE 11

| Property | C* | Ex. 9 |
|---|---|---|
| Cream time, sec | 10 | 8 |
| Gel time, sec | 37 | 36 |
| Tack Free Time, sec | 100 | 95 |
| Core Density, g/L | 44.0 | 43.0 |
| 10° C. K factor, mW/m-K | 19.9 | 19.1 |
| Compressive Strength, kPa | 134 | 111 |
| LOI, % | 28.6 | 29.1 |

An increase in LOI and decrease in k-factor are seen with the imide-modified polyol of the invention.

1. A method of making an imide-modified polyol composition, comprising the steps of
a) forming one or more imide group-containing compounds having terminal carboxylic acid groups by reacting trimellitic anhydride with an aromatic aminoacid or an aromatic diamine in the presence of 0 to 3 parts by weight of another carboxylic acid anhydride and/or a polycarboxylic acid per 100 parts by weight of the trimellitic anhydride;
b) optionally combining the one or more imide group-containing compounds having terminal carboxylic acid groups with one or more aromatic dicarboxylic acid derivatives that contain no imide groups selected from aromatic carboxylic acid anhydrides, aromatic dicarboxylic acids, aromatic dicarboxylic acid halides, and aromatic dicarboxylic acid dialkyl esters, wherein the mole ratio of the imide group-containing compounds and the aromatic dicarboxylic acid derivatives is at least 25:75;
c) then esterifying the one or more imide group-containing compounds having terminal carboxylic acid groups and the one or more aromatic carboxylic acid derivatives if present by reaction with one or more polyols having a hydroxyl equivalent weight of 30 to 500 g/equivalent,
wherein the imide-modified polyol composition has an acid number of no greater than 2 mg KOH/gram, has a hydroxyl number of 150 to 275 mg KOH/g and contains 0.50 to 1.75 moles of aromatic imide groups per kilogram of imide-modified polyol composition.

2. The method of claim 1 wherein the aromatic aminoacid or aromatic diamine is one or both of p-aminobenzoic acid, toluene diamine and 1,3-phenylene diamine.

3. The method of claim 1 wherein at least 50% by weight of the one or one or more polyols having a hydroxyl equivalent weight of 30 to 500 g/equivalent have a hydroxyl equivalent weight of 95 to 500.

4. The method of claim 1 wherein step a) is performed in the presence of the one or more polyols having a hydroxyl equivalent weight of 30 to 500 g/equivalent and in the absense of a catalytic amound of an esterification catalyst.

5. The method of claim 1 wherein step b) is not performed, and a product obtained in step c) is combined with one or more aromatic dicarboxylic acid derivatives that contain no imide groups selected from aromatic carboxylic acid anhydrides, aromatic dicarboxylic acids, aromatic dicarboxylic acid halides, and aromatic dicarboxylic acid dialkyl esters and the resulting combination is subjected to esterification and/or transesterification conditions to produce the imide-modified polyol composition.

6. The method of claim 1 wherein step b) is performed, the imide-modified polyol composition is obtained in step c) and the imide-modified polyol composition comprises a mixture of an imide-modified polyol and a polyester polyol corresponding to an esterification product of the one or more aromatic dicarboxylic acid derivatives and the one or more polyols having a hydroxyl equivalent weight of 30 to 500 g/equivalent.

7. An imide-modified polyol composition produced in the process of claim 1.

8. The imide-modified polyol composition of claim 7, which comprises a mixture of an imide-modified polyol and a polyester polyol corresponding to an esterification product of the one or more aromatic dicarboxylic acid derivatives and the one or more polyols having a hydroxyl equivalent weight of 30 to 500 g/equivalent.

9. A method for preparing a rigid isocyanate-based foam, comprising forming a reaction mixture and reacting the reaction mixture to produce the rigid isocyanate-based foam, wherein the reaction mixture comprises
a) at least one aromatic polyisocyanate in an amount to provide an isocyanate index of 100 to 600;
b) polyols, wherein the polyols include at least 25% by weight of the imide-modified polyol composition of claim 7 and 0 to 75% by weight of one or more non-imide-modified polyols, and wherein the imide content of the polyols is 0.125 to 1.75 moles of imide groups per kilogram;
c) at least one blowing agent;
d) at least one halogenated and/or phosphorus-containing flame retardant;
e) at least one foam-stabilizing surfactant; and
f) at least one urethane and/or isocyanate trimerization catalyst.
